(19) United States
(12) Patent Application Publication
(10) Pub. No.: US 2015/0113819 A1
(43) Pub. Date: Apr. 30, 2015

(54) Five Vial Level

(71) Applicant: Mark L. Silberberg, Fallbrook, CA (US)

(72) Inventor: Mark L. Silberberg, Fallbrook, CA (US)

(21) Appl. No.: 14/064,596

(22) Filed: Oct. 28, 2013

(51) Int. Cl. G01C 9/24

(52) U.S. Cl. CPC G01C 9/24
USPC 33/381

(57) ABSTRACT

A level for determining the orientation of a structure that includes a plurality of bubble vials that are secured within the level body in a manner such that, if any one of the bubble vials become broken or otherwise damaged, it can be easily replaced and the level need not be discarded. The body of the level of the invention includes an upper surface having a pair of viewing openings for viewing certain of the bubble vials and a lower surface having a pair of viewing openings for viewing certain of the bubble vials. The level also includes a bulls-eye level that is mounted on the upper surface of the level body and a plurality of magnets that are mounted on the lower surface of the level body for engagement with the structure to be oriented.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to tools used in the construction industry. More particularly, the invention concerns a specially designed five vial leveling tool that has replaceable bubble vials and includes strategically located magnets for removably affixing the tool to structures made of ferrous material.

2. Description of Related Art Including Information Disclosed Under 37 Crf 1.97 and 1.98

Bubble levels of various designs have been suggested in the past and are widely used by construction workers to determine the orientation of a particular structure or surface with respect to a reference axis. A typical bubble level generally comprises an elongated body that has a pair of opposing, generally parallel working surfaces and includes a plurality of openings having bubble vials permanently secured therein. The bubble vials are typically aligned in different directions relative to the working surfaces and function to indicate the orientation of a structure. For example, one vial may be aligned in a direction perpendicular to the working surfaces, another may be aligned in a direction parallel to the working surfaces and a third may be aligned in an angular direction. Typically, the vial contains a fluid and a bubble, and the user views the position of the bubble within the vial to determine the position of the tool relative to the working surfaces.

A novel and highly useful level construction is disclosed in U.S. Pat. No. 7,802,372 issued to the present inventor. This patent, which is entitled “Removable Laser Base Attachment for Bubble Levels”, describes a bubble level that includes a body, a laser beam generator, and a removable securement. The body has a flat top surface that the level is secured to and a bottom surface that is flat and parallel to the top surface. A laser diode mounted in a module emits a visible laser beam upon application of power from a battery that is controlled by a switch. The module, batteries, and switch are mounted in a through bore in the body. The laser base is removably secured to the bubble level by any manner appropriate to the shape of the level. In one such securement, the level has a T-shaped cross-section and the body has a complementary slot into which the level slides. When the level reference surface abuts the top surface of the laser base, a thumb screw is tightened to frictionally secure the level in the base.

### BRIEF SUMMARY OF THE INVENTION

It is an object of the present invention to provide a specially designed five vial leveling tool for use in accurately and expeditiously ensuring that a surface or angle is level or plumbed properly. The tool includes strategically located structure engaging surfaces and is uniquely provided with a plurality of differently oriented bubble vials that are secured within the tool body in a manner such that, if any one of the bubble vials is broken, or otherwise damaged, it can be easily replaced and the level need not be discarded.

Another object of the invention is to provide a tool of the character described in the preceding paragraph in which the bubble vials are securely held in position within threaded chambers formed in the level body by easily removable threaded cap screws.

Another object of the invention to provide a tool of the aforementioned character in which the body of the leveling tool is provided with a plurality of viewing openings that permit the user to clearly view selected bubble vials from both the top and the front of the tool.

Another object of the invention is to provide a tool of the class described that is provided with a plurality of spaced apart magnets that function to permit the tool to be conveniently, removably connected to any ferrous structure that is being oriented.

Another object of the invention is to provide a tool of the character described which includes a bulls-eye level that is mounted on the top of the tool body.

Yet another object of the invention is to provide a tool of the type described in which at least one of the surfaces of the tool includes a centrally disposed, generally V-shaped groove for longitudinally centering tubular shaped work pieces.

These and other objects of the invention will be realized by the level construction illustrated in the drawings and described in the paragraphs that follow.

### BRIEF DESCRIPTION OF SEVERAL VIEWS OF THE DRAWINGS

FIG. 1 is a generally perspective view of one form of the five vial leveling tool of the invention.

FIG. 2 is a left side view of the tool shown in FIG. 1.

FIG. 3 is a right side view of the tool shown in FIG. 1.

FIG. 4 is a top plan view of the tool shown in FIG. 1.

FIG. 5 is a bottom plan view of the tool shown in FIG. 1.

FIG. 6 is a cross-sectional, exploded view taken along lines 6-6 of FIG. 4.

### DETAILED DESCRIPTION OF THE INVENTION

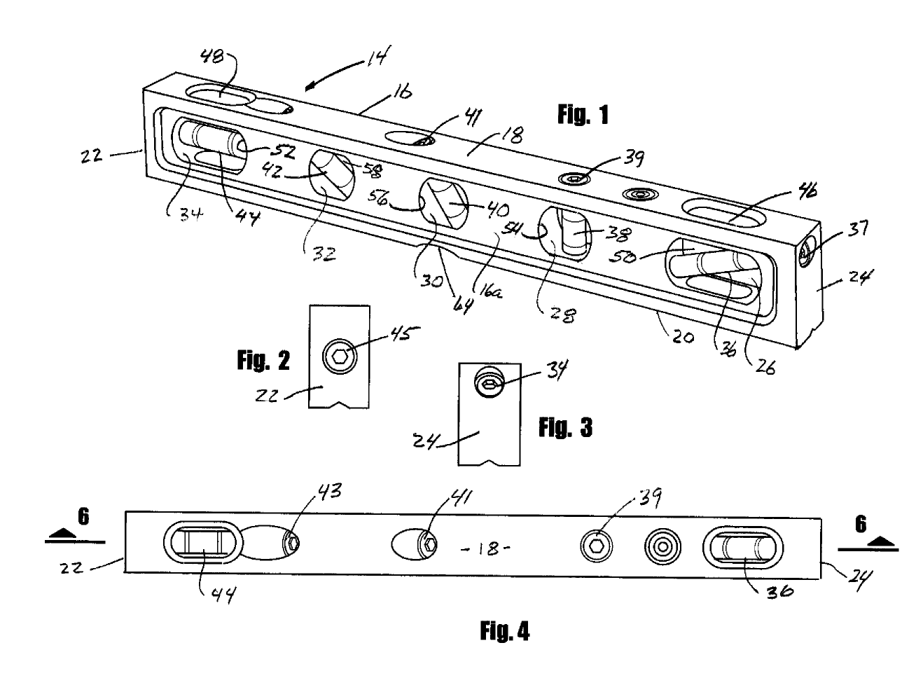

Referring to the drawings and particularly to FIGS. 1 through 5, one form of the five vial leveling tool of the present invention is there shown and generally designated by the numeral 14. Tool 14 here comprises an elongate body 16 having a top surface 18, a bottom surface 20 and first and second end portions 22 and 24 respectively. As best seen in FIGS. 1 and 6 of the drawings, the central portion 16a of body 16 has a plurality of differently oriented vial chambers 26, 28, 30, 32 and 34.

Referring particularly to FIG. 6 of the drawings, it can be seen that vial chamber 26 has a threaded end portion 26a and a central axis 26b that is disposed at an acute angle of approximately 22½ degrees with respect to bottom surface 20. Similarly, vial chamber 28 has a threaded end portion 28a and a central axis 28b that is disposed at an angle of approximately 90 degrees with respect to bottom surface 20. Vial chamber 30 has a threaded end portion 30a and a central axis 30b that is disposed at an angle of approximately 45 degrees with respect to bottom surface 20. Vial chamber 32 has a threaded end portion 32a and a central axis 32b that is disposed an angle of approximately 30 degrees with respect to bottom surface 20. Vial chamber 34 has a threaded end portion 34a and a central axis 34b that is disposed in a generally parallel relationship with bottom surface 20.

A conventional first bubble vial, or spirit vial 36 is disposed within vial chamber 26 and is uniquely removably secured there within by a threaded vial securement connector that is threadably receivable within threaded opening 26a of vial chamber 26 so that vial 36 is disposed at an acute angle of approximately 22½ degrees with respect to top surface 18. The threaded vial securement connector, which is here provided in the form of a conventional cap screw 37 (FIG. 6), is moveable between first and second positions to secure the bubble vial 36 within vial chamber 26 (FIG. 1). A conventional second bubble vial, or spirit vial 38 is disposed within vial chamber 28 and is uniquely removably secured there within by a threaded connector that is threadably receivable within threaded opening 28a of vial chamber 28 so that vial 38 is disposed at an angle of approximately 90 degrees with respect to top surface 18. The threaded connector, which is also here provided in the form of a conventional cap screw 39 (FIG. 6), is moveable between first and second positions to secure the bubble vial 38 within vial chamber 28 (FIG. 1). In similar manner, a conventional third bubble vial, or spirit vial 40 is disposed within vial chamber 30 and is uniquely removably secured there within by a threaded connector that is threadably receivable within threaded opening 30a of vial chamber 30 so that vial 40 is disposed at an angle of approximately 45 degrees with respect to top surface 18. Once again, the threaded connector is provided in the form of a conventional cap screw 41 (FIG. 6) that is moveable between first and second positions to secure the bubble vial 40 within vial chamber 30 (FIG. 1). In like manner, as shown in FIG. 1, a conventional fourth bubble vial, or spirit vial 42 is disposed within vial chamber 32 and is removably secured there within by a conventional cap screw 43 (FIG. 6) so that vial 42 is disposed at an angle of approximately 30 degrees with respect to top surface 18. Cap screw 43 is moveable between first and second positions to secure the bubble vial 42 within vial chamber 32. As is also shown in FIG. 1, a conventional fifth bubble vial, or spirit vial 44 is disposed within vial chamber 34 and is removably secured there within by a conventional cap screw 45 (FIG. 6) so that vial 44 is disposed in a substantially parallel relationship with top surface 18. This cap screw 45 is moveable between first and second positions to secure the bubble vial 44 within vial chamber 34.

With the construction thus described, any one of the five bubble vials of the tool can be conveniently removed and replaced by simply removing the threaded cap screw from the threaded end portion of the vial chamber and then by removing the bubble vial from its chamber. Unlike the prior art levels, if a given bubble vial is broken, or otherwise damaged, it can be easily replaced and the level need not be discarded.

As illustrated in the drawings, the upper surface 18 of body 16 is provided with a first viewing window 46 for viewing the first bubble vial 36 and a second viewing window 48 for viewing the fifth bubble vial 44. The central portion 16a of body 16 is provided with a third viewing window 50 for also viewing the first bubble vial 36 and a fourth viewing window 52 for viewing the fifth bubble vial 44. Additionally, the central portion 16a of body 16 is provided with a fifth viewing window 54 for viewing the second bubble vial 38, a sixth viewing window 56 for viewing the third bubble vial 40 and a seventh viewing window 58 for viewing the fourth bubble vial 42. With this construction, the workman is accorded a clear view of the various bubble vials of the tool so that the various surfaces and angles of the work piece can be accurately and expeditiously leveled and plumbed in a manner well understood by those skilled in the art.

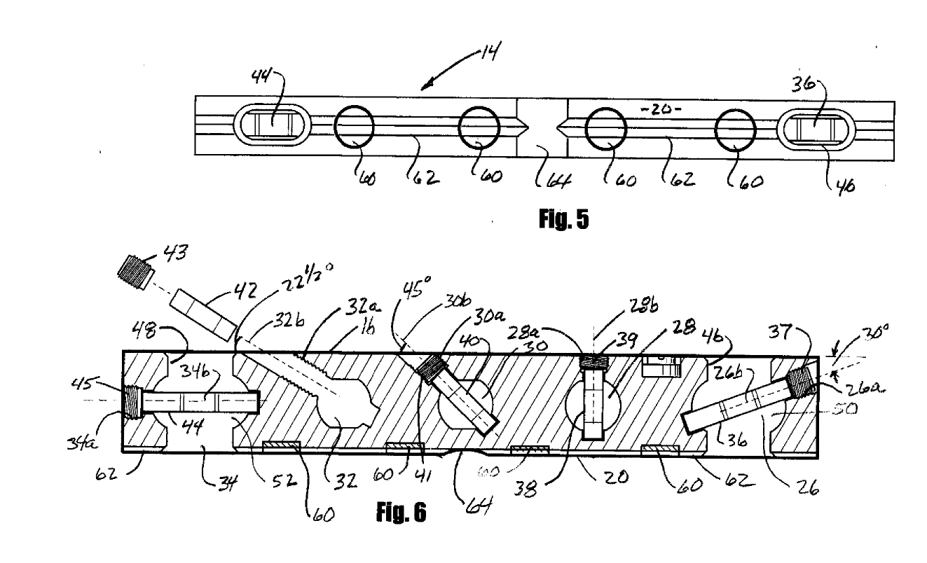

Turning now to FIG. 5 of the drawings, the apparatus of the invention can also be used to orient a ferrous metal structural member, such as an elongated pipe (not shown). When so used, bottom surface 20 of body 16 is first positioned in engagement with the pipe. Because bottom surface 20 is uniquely provided with a plurality of differently configured connector members, namely a plurality of spaced apart magnets 60 (see FIGS. 5 and 6), the elongated pipe will be securely held in engagement with bottom surface 20 by these magnetic connector members. Additionally, because bottom surface 20 is also provided with a generally V-shaped groove 62 along its length (see also FIGS. 5 and 6), the pipe will be removably received within the groove and will be held longitudinally centered with bottom surface 20. Bottom surface 20 is also provided with a centrally located, arcuate recess 64 that permits the level to be balanced on a curved surface, such as the surface of a pipe.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. A leveling tool comprising:
(a) a body having a top surface, a bottom surface and first and second end surfaces, said body having a plurality of vial chambers, each said vial chamber having a threaded opening;
(b) a bubble vial disposed within each of said vial chambers of said body;
(c) a threaded vial securement connector receivable within said threaded opening of each of said vial chambers for movement between first and second positions to secure said bubble vials within said vial chambers; and
(d) at least one magnet connected to said bottom surface of said body.

2. The leveling tool as defined in claim 1 further including a bulls-eye level connected to said top surface of said body.

3. The leveling tool as defined in claim 1 in which said bottom surface is provided with a longitudinally extending, generally V-shaped groove.

4. The leveling tool as defined in claim 1 in which at least one of said plurality of bubble vials is disposed at an angle with respect to said top surface of said body.

5. The leveling tool defined in claim 1 in which at least one of said plurality of bubble vials is disposed in a parallel relationship with said top surface of said body.

6. The leveling tool as defined in claim 1 in which said top surface is provided with a pair of spaced apart viewing openings.

7. The leveling tool as defined in claim 1 in which said bottom surface is provided with a pair of spaced apart viewing openings.

8. A leveling tool comprising:
(a) a body having a top surface, a bottom surface and first and second end surfaces, said body having:
(i) a first vial chamber having a threaded opening;
(ii) a second vial chamber having a threaded opening;
(iii) a third vial chamber having a threaded opening;
(iv) a fourth vial chamber having a threaded opening; and
(v) a fifth vial chamber having a threaded opening;
(b) a first bubble vial removably secured within said first vial chamber of said body, said first bubble vial extending at an acute angle with respect to said top surface of said body;
(c) a second bubble vial removably secured within said second vial chamber of said body, said second bubble vial extending substantially perpendicular to said top surface of said body;
(d) a third bubble vial removably secured within said third vial chamber of said body, said third bubble vial extending at about a 45° angle with respect to said top surface of said body;
(e) a fourth bubble vial removably secured within said fourth vial chamber of said body, said fourth bubble vial extending at about a 30° angle with respect to said top surface of said body; and
(f) a fifth bubble vial removably secured within said fifth vial chamber of said body, said fifth bubble vial extending substantially parallel to said top surface of said body.

9. The leveling tool as defined in claim 8 further including a bulls-eye level connected to said top surface of said body.

10. The leveling tool as defined in claim 8 in which said top surface is provided with a first viewing opening for viewing said first bubble vial and a second viewing opening for viewing said fifth bubble vial.

11. The leveling tool as defined in claim 8 in which said bottom surface is provided with a first viewing opening for viewing said first bubble vial and a second viewing opening for viewing said fifth bubble vial.

12. The leveling tool as defined in claim 8 in which said first bubble vial extends at an acute angle of about 22½° with respect to said top surface of said body.

13. The leveling tool as defined in claim 8 further including a threaded vial securement connector receivable within said threaded opening of each of said vial chambers for movement between first and second positions.

14. The leveling tool as defined in claim 8 further including a plurality of magnets connected to said bottom surface of said body.

15. The leveling tool as defined in claim 14 in which said bottom surface is provided with a longitudinally extending, generally V-shaped groove.

16. A leveling tool comprising:
(a) a body having a top surface having a pair of spaced apart viewing openings, a bottom surface having a pair of spaced apart viewing openings and a longitudinally extending, generally V-shaped groove and first and second end surfaces, said body having a plurality of vial chambers, each said vial chamber having a threaded opening;
(b) a plurality of bubble vials carried by said body with a selected bubble vial being removably secured within each of said vial chambers of said body;
(c) a threaded vial securement connector receivable within said threaded opening of each of said vial chambers for movement between first and second positions to secure said bubble vials within said vial chambers;
(d) a plurality of spaced apart magnets connected to said bottom surface of said body; and
(e) a bulls-eye level connected to said top surface of said body.

17. The work positioning and leveling tool as defined in claim 16 in which at least one of said plurality of bubble vials is disposed at an angle with respect to said top surface of said body.

18. The work positioning and leveling tool defined in claim 16 in which at least one of said plurality of bubble vials is disposed in a parallel relationship with said top surface of said body.

19. The work positioning and leveling tool as defined in claim 16 in which at least one of said plurality of bubble vials is disposed at an acute angle with respect to said top surface of said body.

20. The work positioning and leveling tool as defined in claim 16 in which said bottom surface of said body is provided with an arcuate recess.
